(19) United States
(12) Patent Application Publication
(10) Pub. No.: US 2006/0204701 A1
(43) Pub. Date: Sep. 14, 2006

(54) Decorative film and method of manufacturing

(75) Inventor: Heidi Eichenberger, La Peche (CA)

Correspondence Address: FROMMER LAWRENCE & HAUG, 745 FIFTH AVENUE- 10TH FL., NEW YORK, NY, 10151, US

(73) Assignee: PIVOT DECO INC.

(21) Appl. No.: 11/127,830

(22) Filed: May 12, 2005

(30) Foreign Application Priority Data
Mar. 14, 2005 (CA) 2,500,607

(51) Int. Cl. B32B 33/00

(52) U.S. Cl. 428/40.1; 428/42.3

(57) ABSTRACT

A decorative film which can be used as floor or wall borders and its method of manufacture are disclosed. The decorative film can also be used for other areas and application substrates, such as providing a graphic medallion-like design for an entrance way, as a demarcation to define an area, as a mean to accent a section of a room or furniture, as an ornate, or showing designs on ceilings and table tops. The film is comprised of a transparent film substrate having an upper side and an underside, a plurality of designs affixed on either side of the film substrate, and an adhesive layer applied to the underside of the film substrate. Depending on the types of film substrate materials used, the transparency of the film can enable it to substantially show the original colour and material texture of the surface of the application substrates.

### FIELD OF THE INVENTION

This application claims priority benefits of Canadian Patent Application Serial Number 2,500,607 filed Mar. 14, 2005.

The present invention relates to decorative films for easy applications on floors, ceilings and walls and the like. The invention also relates to a method of manufacturing such decorative films.

### BACKGROUND OF THE INVENTION

Floor inlaids, medallions, parquets and stencils are commonly used to decorate wooden, laminated or vinyl floors. For instance, U.S. Pat. No. 4,379,185 (issued Apr. 5, 1983 to Smith et al.) discloses a method for manufacturing inlaid vinyl sheeting. U.S. Pat. No. 4,278,483 (issued Jul. 14, 1981 to Mansolillo) teaches a process for producing a decorative surface covering with an inlaid decoration. Similarly, a decorative surface covering with a multicoloured, fused plastisol layer is taught in U.S. Pat. No. 5,645,889 (issued Jul. 8, 1997 to Potosky et al.). While many of these inlaid decorative surfaces produce the desired aesthetic results, they are both expensive and labour-intensive to construct and apply.

For wooden floors, it is common to enhance the aesthetic appearance with medallions, parquets or stencil paintings. However, both medallions and parquets are costly and require specialized technicians to install. With respect to stencil paintings, while it is relatively inexpensive, it takes a lot of dexterity and determination from the users, not to mention the artistic skills and the lack of longevity due to premature wear and tear.

Wall borders have been widely used to decorative certain parts of the wall. However, the conventional method to affix wall borders involves messy application of glue on the underside of the borders followed by pasting the borders on the desired positions. This affixing process is particularly challenging when the length of the border is excessively lengthy.

It is therefore advantageous to have an easy-to-use adhesive decorative film for users to apply on either floor or wall surface without the need to employ significant amount of agility. Such film will work like a sticker or decal. There are, in fact, such stickers being used for decorations and advertisements.

Floor graphics and decors are gaining popularity in recent years. Typically, these graphics are made of polycarbonate or vinyl materials. Custom designed graphics are printed on the upper surface and adhesives are provided on the under surface of these decors. Some of these decors cover a large area, such as the open foyer of a store entrance, in order to catch the attention of customers. Some are applied on risers of steps (see U.S. Pat. No. 6,041,533, issued Mar. 28, 2000 to Lemmond, Jr.). While it is no doubt that floor decors are easy to apply, they are, however, not intended to be used for any extended period of time. Moreover, nearly all floor decors carry a promotional message, they are usually not made of transparent material. Due to the inherent requirements of floor decors, it would be impossible for a user to show the background colour or material texture of the floor substrate on which the decor is affixed.

Accordingly, it is advantageous to produce a decorative film for easy application on floors and walls and other desirable surfaces whereby the film is made of transparent material such that while the decorative design is affixed on the substrate, the colour and material texture of the substrate, such as hardwood floors, remain visible.

### SUMMARY OF THE INVENTION

An object of the present invention is to provide a decorative film which can be used as floor or wall borders. The decorative film can also be used for other areas and applications, such as a graphic medallion-like design for an entrance way, as a demarcation to define an area, as a mean to accent a section of a room or furniture, as an ornate, and on ceilings and table tops, or as mural materials. When affixed on the floor, the decorative film of the present invention can also be designed to indicate directions in public areas, such as schools, hospitals and arenas.

Another object of the present invention is to provide a cost-effective way to manufacture the decorative film disclosed herein. The film of the instant invention possesses anti-slip, anti-scratch qualities. It can also endure chemical floor buffers, waxes, solvents, grime, dirt, grease, grit, scuff mark, wax strippers, etc.

According to one aspect of the present invention, it provides a decorative film comprised of a transparent film substrate having an upper side and an underside, a plurality of designs affixed on either side of the film substrate, and an adhesive layer applied to the underside of the film substrate.

The present invention will become more fully understood from the detailed description given herein below and the accompanying drawings, given by way of illustration only and thus not intended to be limitative of the present invention.

### BRIEF DESCRIPTION OF THE DRAWINGS

FIG. 1 is a top view of a preferred embodiment of the decorative film of the present invention illustrating the decorative designs printed on the decorative film substrate thereon.

FIG. 2 is a cross-sectional view of a preferred embodiment of the decorative film of the present invention.

FIG. 3 is a perspective view of the floor and wall decorative films of the present invention being applied on the floor and the wall, respectively.

### DETAILED DESCRIPTION OF THE PREFERRED EMBODIMENT

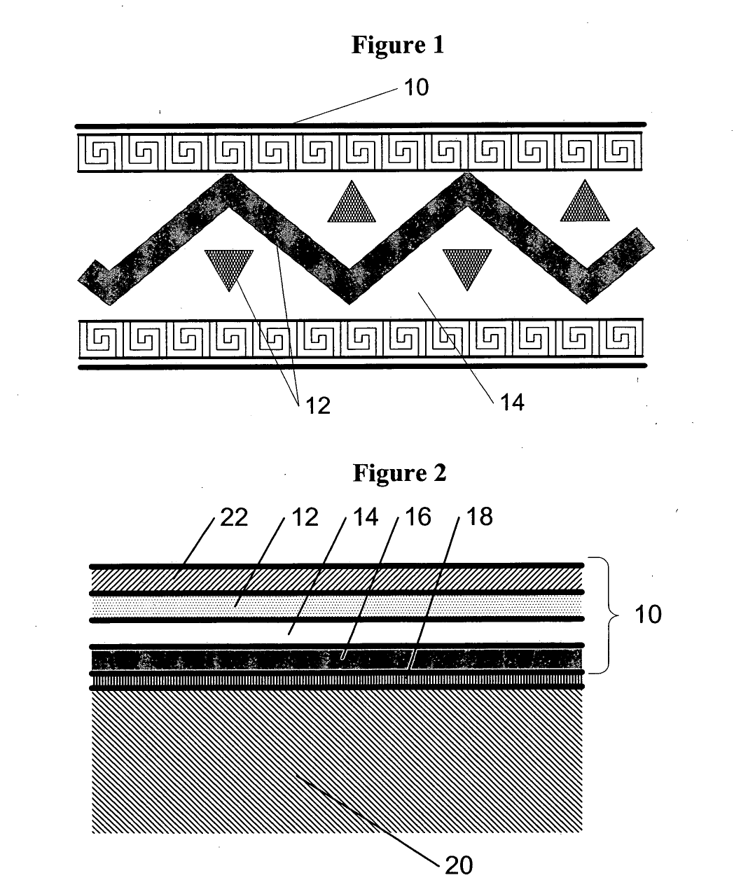

In order that the invention may be more fully understood, it will now be described, by way of example, with reference to the accompanying drawings in which FIGS. 1 through 3 illustrate a preferred embodiment of the present invention being a decorative film suitable to be used on various indoor application substrates, such as wooden floors, walls, ceilings and the like.

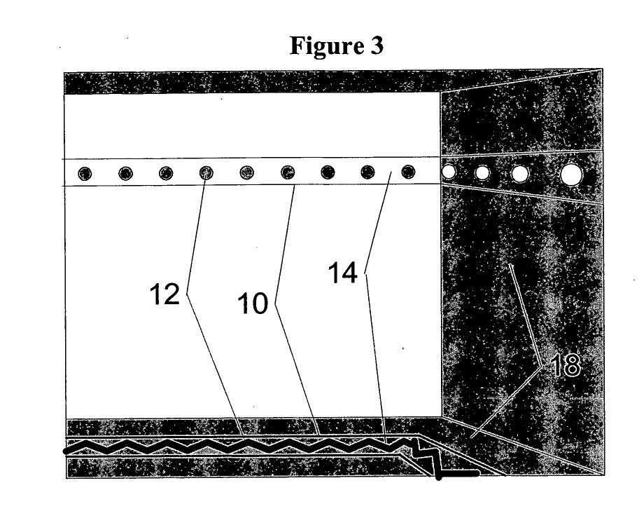

Referring now to FIG. 1 which illustrates a top view of decorative film 10 of the present invention. Decorative film 10 can be of any size and shape. Preferably, decorative film 10 takes the shape of an elongated strip. Decorative film 10 comprises a transparent film substrate 14 and a plurality of decorative designs 12. While decorative designs 12 can be affixed on either the upper side or the underside of film substrate 14, they are preferably printed on the upper side. The terms “upper side” and “underside” used herein means the side which faces away and faces toward the application substrate 20, respectively (see FIG. 2). Decorative designs 12 can be opaque, translucent in colour or transparent in colour.

As can be seen from FIG. 2, the cross-sectional view shows the construction of decorative film 10 when applied to application substrate 20. Application substrate 20 has a surface 18 for decorative film 10 to be adhered thereon. An adhesive layer 16 is coated on the underside of film substrate 14. When the film substrate 14 is manufactured, a releasable backing liner (not shown) is used to guard the adhesive layer 16. During application, the user peels off the releasable backing liner from adhesive layer 16 and apply pressures to press decorative film 10 against application surface 18. While the preferred embodiment teaches pressure sensitive adhesion, other conventional means of adhesion, such as applying moisture-sensitive or solvent-based adhesive, can be used to affix decorative film 10 on the surface of application substrate 18.

When decorative film 10 is being applied on a floor, especially in areas with high traffic volume, it is desirable to protect the decorative designs 12 from constant wear and tear with an optional clear protective layer 22. Protective layer 22 can be made of any suitable materials, such as thermoplastic polymer based film with transparent property, or can be an overlaminate layer applied to the upper side of film substrate 14 and covers decorative designs 12.

Film substrate 14 is preferably made of flexible film with transparent properties. The flexible film allows easy handling and storage. Depending on the type of film substrate materials used, the transparency of the film can enable the colour and material texture of the application surface 18 to substantially come through.

In order to prolong the life span of decorative film 10, besides applying an optional protective layer 22 on the upper side of the substrate, the present invention also provides for the upper side of the substrate itself to be made from materials which is anti-slip, anti-scratch with the ability to endure chemical floor buffers, waxes, solvents, grime, dirt, grease, grit, scuff mark, wax strippers, etc.

The decorative films of the present invention can be used in a variety of applications. For instance, the decorative filmstrips can be used as decorative floor borders (see FIG. 3), to define a particular area inside a building, such as the kitchen or dinning room, to decorate a hallway or an entrance, as a mean to accent a section of a room or furniture or as an ornate.

When a user wants to decorate the walls with designs or to blend in with the immediate wall colour or to add signage but prefers to show the original colour and material texture of the wall underneath, then instead of applying the conventional wallpapers, the filmstrips of the present invention can be used (see FIG. 3). Their ease of application also makes it an ideal choice since pasting conventional wallpapers near the ceiling can be challenging for an untrained user.

Decorative films of the present invention are not restricted to filmstrips. They can take on a variety of shapes and sizes. For example, a user may create her own custom-made medallion or a design of a Persian rug and apply them in the foyer of a building or a mural on the wall. Likewise, designs with different dimensions can be applied on ceiling surfaces or tabletops. In certain unique circumstances, the decorative designs may take the form of arrows or coloured lines and used on floor surfaces of public facilities in order to indicate directions.

The present invention also provides a method for manufacturing decorative film 10.

Flexible, clear and transparent film made from polyester, polyethylene, polystyrene, polycarbonate or acrylic can be used as film substrate 14. Decorative designs 12 are then affixed on either the upper side or the underside of film substrate 14 by using conventional techniques such as coating, digital printing, screen-printing or transfer laminating method. To protect the graphics from damages resulted from chemical floor buffers, waxes, solvents, grime, dirt, grease, grit, scuff mark, wax strippers, etc. and to provide an anti-slip, anti-scratch surface, an optional clear protective layer 22 can be overlaminated to the upper side of film substrate 14 and covers decorative designs 12. Alternatively, the film substrate 14 is made from materials which can endure these hazards.

An adhesive layer 16 is applied to the underside of the film substrate 14. Suitable adhesive can be either pressure- or moisture-sensitive or solvent based. For pressure-sensitive adhesive, the user applies suitable pressure to the film substrate 14 against the surface 18 of the application substrate 20. In the case of moisture-sensitive adhesive, the adhesive layer 16 cures through the exposure to moisture. This can happen in one of two ways. In most cases, the water molecules react with a stabilizer to render them inert. With the stabilizer inert, the polymer chains in the adhesive naturally react, cross-linking and creating a solid polymer, creating the desirable adhesive effect. With respect to solvent-based adhesive, instead of reacting with moisture, the adhesive layer 16 has a high level of solvent which acts as a stabilizer. Once exposed to air, the solvent evaporates off and the adhesive reacts.

An example of a pressure-sensitive adhesive suitable to be used in the present invention is Ethyl Vinyl Acetate (EVA). Examples of the moisture-sensitive adhesive suitable to be used in the present invention include silicone and urethane. Examples of the solvent-based adhesive suitable to be used in the present invention include Polyvinyl Acetate (PVA) and Butyl Rubber (NBR).

In order to prevent the adhesive layer 16 from unnecessary or accidental exposure, a releasable backing liner is used to guard the adhesive layer 16.

It is clear that the inventive concept of this decorative film is not limited to the preferred embodiments and designs and applications disclosed herein. Any suitable application substrates can incorporate the present inventive concept and provide for suitable display of the decorative designs and graphics printed on the film substrate. Thus, the embodiments depicted herein are intended to be merely illustrative and not restrictive in any sense.

It is further understood that the present invention may be carried out in other specific ways than those herein set forth without departing from the spirit and essential characteristics of such invention. The present embodiments are, therefore, to be considered in all respects as illustrative and not restrictive, and all changes coming within the meaning and equivalency range of the appended claims are intended to be embraced therein.

What is claimed is:

1. A decorative film comprising a transparent film substrate having an upper side and an underside, a plurality of designs affixed on either side of said film substrate, and an adhesive layer applied to the underside of said film substrate.

2. The decorative film of claim 1, further comprising a protective layer overlaminated on the upper side of said film substrate.

3. The decorative film of claim 1, wherein said film substrate is made of flexible materials.

4. The decorative film of claim 1, wherein said film substrate is made from polyester, polyethylene, polystyrene or polycarbonate.

5. The decorative film of claim 4, wherein said film substrate has anti-slip and anti-scratch properties.

6. The decorative film of claim 5, wherein said film substrate further possesses enduring properties from damages resulted from chemical floor buffers, waxes, solvents, grime, dirt, grease, grit, scuff mark or wax strippers.

7. The decorative film of claim 1, wherein said plurality of designs is affixed on said film substrate by coating, digital printing, screen-printing or transfer laminating method.

8. The decorative film of claim 7, wherein said plurality of designs is opaque, translucent in colour or transparent in colour.

9. The decorative film of claim 1, wherein a releasable backing liner is provided to guard said adhesive layer.

10. The decorative film of claim 1, wherein said adhesive layer is made from pressure-sensitive, moisture-sensitive or solvent-based compound.

11. The decorative film of claim 10, wherein said pressure-sensitive compound is Ethyl Vinyl Acetate (EVA).

12. The decorative film of claim 10, wherein said moisture-sensitive compound is silicone or urethane.

13. The decorative film of claim 10, wherein said solvent-based compound is Polyvinyl Acetate (PVA) and Butyl Rubber (NBR).

14. The decorative film of any of claims 1, wherein said decorative film is a filmstrip.

15. A method for manufacturing a decorative film comprised of a transparent film substrate have an upper side and underside, a plurality of designs affixed on either side of said film substrate, and an adhesive layer applied to the underside of said film substrate, wherein said method comprising the steps of (i) affixing said plurality of designs on either side of said film substrate, (ii) applying said adhesive layer to the underside of said film substrate, and (iii) placing a releasable backing liner on said adhesive layer.

16. The method for manufacturing a decorative film of claim 15, further comprising the step of (iv) applying a protective layer made of thermoplastic polymer based film with transparent property to the upper side of said film substrate.
